(19) United States
(12) Patent Application Publication
(10) Pub. No.: US 2021/0224740 A1
(43) Pub. Date: Jul. 22, 2021

(54) MERCHANDISE DELIVERY MANAGEMENT SYSTEM AND PROGRAM

(71) Applicant: Kazunori FUJISAWA, Tokyo (JP)

(72) Inventor: Kazunori FUJISAWA, Tokyo (JP)

(21) Appl. No.: 16/972,230

(22) PCT Filed: Apr. 22, 2019
(86) PCT No.: PCT/JP2019/016920

§ 371 Date: Dec. 4, 2020

(30) Foreign Application Priority Data
Jun. 25, 2018 (JP) 2018-119958

(51) Int. Cl. G06Q 10/08; G06Q 30/02; G06Q 50/30

(52) U.S. Cl. CPC G06Q 10/08355; G06Q 30/0283; G06Q 50/30; G06Q 30/0282

(57) ABSTRACT

An improved commodity delivery management system and the like are provided. A commodity delivery management system includes: a management server that manages delivery of a commodity from one or more near sites each having, as a delivery coverage area, a predetermined area allowing distribution to a customer home in a predetermined time period, to the customer home; a terminal of the customer; and a terminal of a delivery worker undertaking delivery of the commodity ordered from the terminal of the customer, wherein for assigning the delivery worker the commodity to be delivered, the management server issues, to the terminal of the delivery worker, a delivery offer notification that presents the commodity for each delivery destination area, and a compensation fee receivable when the commodity is delivered, and allows the delivery worker to which the delivery offer notification has been issued, to select the commodity for each delivery area, through the terminal of the delivery worker.

### TECHNICAL FIELD

The present invention broadly relates to a management system and the like that manage distribution and delivery of products and commodities, and more specifically, to a system, program and the like for managing delivery and the like of commodities distributable in retail businesses and online shopping businesses.

### BACKGROUND ART

Conventionally, to reduce the distribution cost, a technology of offering jobs for those who intend to provide distribution or delivery, instead of relying on a dedicated delivery business, and of assigning distribution or delivery operations and the like on a predetermined condition.

For example, conventional transportation operations are performed through dedicated transporter vehicles by dedicated transportation businesses and full-time staff members. In view of the fact that the transportation cost for timely transporting small quantities of packages not through a regular service or the like is high, an idea of performing transportation operations using traveling operations performed during daily commutes by corporate employees and students has been proposed (Patent Literature 1).

That is, Patent Literature 1 discloses the idea preliminarily assuming that jobs for temporary staff members transporting packages are offered on a website accessible from information terminals, such as personal computers and mobile phones, in transportation operations, interviews or the like are held as required, and employment contracts are signed.

Furthermore, a delivery system has also been proposed that uses existing facilities and networks to allow reduction in waste of energy consumption and, in turn, in cost (Patent Literature 2).

That is, Patent Literature 2 discloses a delivery system that includes: an Internet delivery server that constructs information about article delivery as a database, and manages delivery operations; a plurality of user communication terminals which are connected to the Internet delivery server and through which a delivery request and a delivery application are issued to the Internet delivery server, and a delivery request approval and a delivery application approval are obtained from the Internet delivery server; and a plurality of distribution stations where delivery articles are delegated from delivery clients, and the delivery articles are passed to a plurality of unemployed transporters, the unemployed transporters transporting articles about which the delivery application approval has been obtained from the Internet delivery server, wherein the delivery system uses the Internet and the unemployed transporters.

Furthermore, an effective distribution management device and the like have also been proposed that are capable of drastically reduce the distribution cost, and allowing a user to receive the distribution article on a desired date and time (Patent Literature 3).

That is, Patent Literature 3 discloses a distribution management device that includes: a distribution information reception part for receiving the input of shipping and deposit place information for a distribution object from a sender, and receiving the input of receiving place information for the distribution object from a receiver; a deliverer determination part for notifying at least the shipping and deposit place information and the receiving place information, recruiting users who wish to distribute the distribution object, and determining a deliverer based on a predetermined rule from among the recruited users; and a distribution procedure notification part for at least notifying the deliverer of the information necessary for taking out the distribution object from the shipping and deposit place, or a relay storage place where another deliverer stores the delivery article, and the information necessary for storing the delivery article in the relay storage place or the receiving place, and notifying the receiver of the information necessary for taking out the delivery article from the receiving place where the deliverer stores the delivery article.

### CITATION LIST

### Patent Literature

Patent Literature 1: Japanese Patent Laid-Open No. 2002-297722
Patent Literature 2: Japanese Patent Laid-Open No. 2002-053213
Patent Literature 3: Japanese Patent Laid-Open No. 2015-003778

### SUMMARY OF INVENTION

### Technical Problem

However, the conventional distribution management device and the like have, for example, room for further improvement related to the deliverer recruiting method, the delegation method, compensation setting and the like. If such improvement can be achieved, it is expected to result in coming reform of working practices.

### Solution to Problem

Accordingly, a commodity delivery management system according to one embodiment of the present invention is a commodity delivery management system including: a management server that manages delivery of a commodity from one or more near sites each having, as a delivery coverage area, a predetermined area allowing distribution to a customer home in a predetermined time period, to the customer home; a terminal of the customer; and a terminal of a delivery worker undertaking delivery of the commodity ordered from the terminal of the customer, wherein for assigning the delivery worker the commodity to be delivered, the management server issues, to the terminal of the delivery worker, a delivery offer notification that presents the commodity for each delivery destination area, and a compensation fee receivable when the commodity is delivered, and allows the delivery worker to which the delivery offer notification has been issued, to select the commodity for each delivery area, through the terminal of the delivery worker.

The compensation fee receivable when the commodity is delivered is determined according to a sales price of the commodity.

### Advantageous Effects of Invention

The commodity delivery management system and the like according to one embodiment of the present invention exert advantageous effects of allowing providing a system that improves an incentive for the deliverer to the distribution operation, by an improved method of offering jobs for deliverers, delegation method, and compensation setting and the like.

### BRIEF DESCRIPTION OF DRAWINGS

FIG. 1 illustrates facilities, distribution paths and the like in a commodity delivery management system according to one embodiment of the present invention.

FIG. 2 illustrates an entire configuration example of the commodity delivery management system according to one embodiment of the present invention.

FIG. 3 illustrates a functional block configuration of a management server in the commodity delivery management system according to one embodiment of the present invention.

FIG. 4 illustrates an appearance configuration example of an information processing apparatus (a delivery worker terminal and/or a user terminal) in the commodity delivery management system according to one embodiment of the present invention.

FIG. 5 illustrates a functional block configuration of hardware constituting the information processing apparatus according to one embodiment of the present invention.

FIG. 6 illustrates a concept of cooperation operation of the commodity delivery management system according to one embodiment of the present invention.

FIG. 7 illustrates a basic concept of a workflow through the commodity delivery management system according to one embodiment of the present invention.

FIG. 8 illustrates a specific flow of the workflow through the commodity delivery management system according to one embodiment of the present invention.

FIG. 9 illustrates a flow of processing operations in the commodity delivery management system according to one embodiment of the present invention.

FIG. 10 illustrates a flow of processing operations in the commodity delivery management system according to one embodiment of the present invention.

FIG. 11 illustrates a display example of an information processing apparatus (a delivery worker terminal) in the commodity delivery management system according to one embodiment of the present invention.

FIG. 12 is a flowchart illustrating a processing operation flow in the commodity delivery management system according to one embodiment of the present invention.

FIG. 13 is a flowchart illustrating a processing operation flow in the commodity delivery management system according to another embodiment of the present invention.

FIG. 14 is a flowchart illustrating a processing operation flow in the commodity delivery management system according to one embodiment of the present invention.

### DESCRIPTION OF EMBODIMENTS

Hereinafter, a commodity delivery management system and the like according to one embodiment of the present invention are described in detail with reference to the drawings.

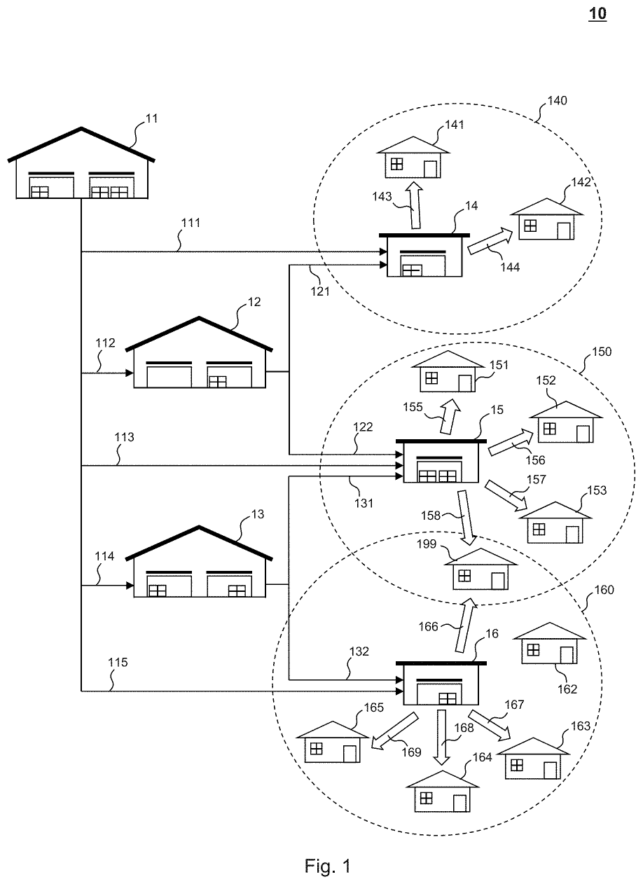

FIG. 1 schematically shows facilities, distribution paths and the like in a commodity delivery management system (hereinafter, also simply called “management system”) according to one embodiment of the present invention. In this diagram, the commodity delivery management system 10 viewed from the facilities and the distribution paths includes logistics centers 11 to 13, and near sites 14 to 16, in a roughly classified manner, and constitutes a part of a major logistics network distributing commodities and the like through paths 143 and 144, 155 to 158 and 166 to 169, to customer homes 141 and 142, 151 to 153, 162 to 165, and 199.

Note that the number of logistics centers 11 to 13 and the number of near sites 14 to 16 are not limited to these numbers. Any number of centers and any number of sites can be adopted. Hereinafter, for the sake of convenience of facilitating understanding of the present invention, description is made along the model shown in FIG. 1.

### [Logistics Center and Near Site]

In the commodity delivery management system according to one embodiment of the present invention includes, for example, at least two types of facilities. More specifically, besides logistics centers as conventional logistics sites, near sites are provided as geographical sites allowing distribution to customer homes in a predetermined time period.

That is, the near sites are distribution sites provided so as to allow distribution of commodities and the like to customers in a relatively short time period (for example, about 30 minutes to one hour; about several hours in some cases).

As shown in FIG. 1, the logistics centers may have roles different from each other. For example, in this diagram, the logistics center 12 distributes commodities and the like to the near sites 14 and 15 via the respective paths 121 and 122. The logistics center 13 distributes commodities and the like to the near sites 15 and 16 via the respective paths 131 and 132. Meanwhile, the logistics center 11 distributes commodities and the like to other logistics centers 12 and 13 via the respective paths 112 and 114, while also having a role of distributing commodities and the like to the near sites 14, 15 and 16 via the respective paths 111, 113 and 115. For example, typically, commodities and the like are supplied to the near site 14, typically from geographically near logistics center 12. However, if there is no inventory in the logistics center 12, commodities and the like are supplied from the logistics center 11 to the near site 14 in some cases.

Although not shown in FIG. 1, paths for directly distributing commodities and the like from the logistics centers 11 to 13 to the customer homes may be provided.

In FIG. 1, the near area 140 indicates an area allowing delivery of commodities and the like from the near site 14 in a predetermined time period (for example, 30 minutes, one hour or the like; about several hours in some cases). This area schematically includes customer homes 141 and 142.

Likewise, the near area 150 indicates an area allowing delivery of commodities and the like from the near site 15 in a predetermined time period (for example, 30 minutes, one hour or the like; about several hours in some cases). This area schematically includes customer homes 151, 152, 153 and 199. The near area 160 indicates an area allowing delivery of commodities and the like from the near site 16 in a predetermined time period (for example, 30 minutes, one hour or the like; about several hours in some cases). This area schematically includes customer homes 162, 163, 164, 165 and 199.

Here, in this diagram, the customer home 199 is included in the near area 150 and also in the near area 160, for example. This means that commodities and the like can be delivered to the customer home 199 from the near site 15 and also from the near site 16 in the predetermined time period (for example, commodities and the like can be delivered from the near site 15 to the customer home 199 in 20 minutes, and commodities and the like can be delivered from the near site 16 to the customer home 199 in 30 minutes).

### [Logistics Management]

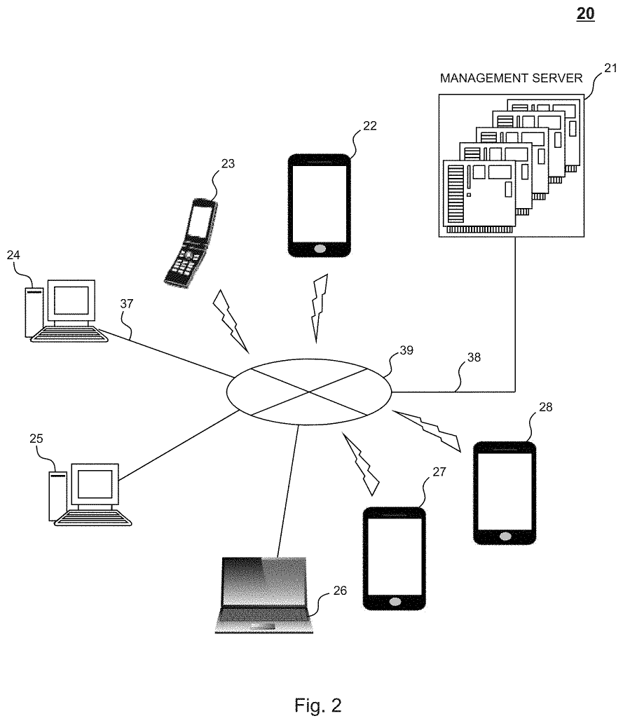

Parts described such that “commodities and the like can be delivered from the near site in the predetermined time period”, “if there is no inventory” and the like in the description so far, can be determined based on the fact that the time period (expected time period) required for distribution or delivery, and the number of inventory items at the site are managed in the system. An entire configuration example of the commodity delivery management system according to one embodiment of the present invention is described later with reference to FIG. 2. Meanwhile, for example, a management server in the commodity delivery management system according to one embodiment of the present invention is installed in any logistics center or near site in FIG. 1 or a premise or the like, not shown. Such a management server is connected to individual centers and sites through information terminals and a network. The inventory situations and the numbers of warehoused and shipped commodities and the like at the individual sites and the like, and distribution or delivery situations between the sites or to the destination and the like are managed from moment to moment. Furthermore, from such achievements and the like, the distribution or delivery time period between sites or to the destination is calculated, and is sequentially updated and managed.

Consequently, each path in FIG. 1 is not always a sole route. For example, the path from the logistics center 11 to the near site 14 is managed, with reference numeral 111, on the system. Alternatively, one or more other routes may be stored and managed as alternative routes. The path from the near site 14 to the customer home 141 is also managed, with reference numeral 143 in the diagram, on the system. However, one or more alternative routes can be stored and managed.

For example, these alternative routes can be alternatively adopted according to traffic situations of the moment, and instructions can be issued to specific distribution facilities (sites) or delivery means (delivery vehicle).

### [Sales Management]

In the commodity delivery management system according to one embodiment of the present invention, sales management of commodities and the like are also performed. The commodity delivery management system according to one embodiment of the present invention cooperates also with store POS registers and a mail-order (electronic commerce) system, not shown, and manages sales achievements at stores and sales achievements through mail order on a customer-by-customer basis. As a database therefor, the following databases (D1) to (D5) are included in the management server according to one embodiment. Reference and an update request are allowed for various terminals.

Note that the databases (D1) to (D5) are examples. Besides these databases, databases or tables can be appropriately generated as required.

### (D1) Customer Management Database

This database is a database where items related to customers are registered, and personal information, such as customer names, addresses, and phone numbers, and supplementary information, such as held points and near sites, are registered.

### (D2) Commodity Management Database

This database is a database where items related to commodities are registered, and commodity names, commodity codes associated with JAN codes, and the like are registered and managed.

### (D3) Inventory Management Database

This database is a database which is for managing the commodity inventory on a site-by-site basis, and appropriately cooperates with the commodity management database to allow required tables to be derived and extracted.

### (D4) Warehouse Management Database

This database is a database for managing the commodity inventory items stored in a warehouse of the logistics center or the like.

### (D5) Sales Management Database

This database is an achievement management database related to commodities sold at each site or store.

### [Delivery Management]

The commodity delivery management system according to one embodiment of the present invention manages delivery from the near site, while having a characteristic of offering jobs for deliverers (also called delivery workers; hereinafter, the same applies), assigning delivery commodities (packages) on a predetermined condition, and managing delivery situations. A further major characteristic is that commodities (packages) are managed with respect to each delivery destination or each destination area, and transportation charges (compensations for delivery workers) are also managed on an area-by-area basis.

In the commodity delivery management system according to one embodiment of the present invention, as a database therefor, the following databases (D6) and (D7) are included in the management server. Reference and an update request are allowed for various terminals.

Note that the databases (D6) and (D7) are examples. Besides these databases, databases or tables can be appropriately generated as required.

### (D6) Delivery Worker Management Database

This database is a database where items related to delivery workers are registered, for example, personal information, such as worker names, addresses, and phone numbers, supplementary information, such as credit ranks and achievements of the workers, and the worker's management information, such as desired delivery areas and desired delivery time slots, are registered.

### (D7) Delivery Management Database

Information items related to delivery management on a stage where commodities are passed to the delivery worker from the near site and delivered (for example, status information and the like on delivery commodities (packages)) are registered and managed.

### [Role of Near Site]

At the near site, the logistics system that includes the commodity delivery management system according to one embodiment of the present invention has the following roles (system operations, operations by operation personnel, such as staff at the site, are collectively listed).

(1) Storing and sorting of target commodities, and update management of target commodities.
(2) Distribution process when an order is placed on a target commodity from a customer in the near area (picking out an ordered commodity, and destination labeling).
(3) Upon delivery from the logistics center, temporary storing of the commodity ordered by the customer in the near area, and distribution to the customer home (typically, the commodity is passed to the near site in a state with destination-labelled).
(4) Bundled distribution of commodities ordered by the customer in the near area (in the case of bundled distribution, a bundling operation and a destination labeling operation are performed at the near site).
(5) Redelivery in case the customer in the near area is absent when delivery is tried.
(6) Concurrent distribution of an additionally ordered commodity when an additional order for the commodity is placed in the case of redelivery in (5).
(7) Handover of the commodity to the delivery worker.
(8) Reception of the commodity from the delivery worker in case the delivery destination is absent.
(9) Redistribution arrangement process for the aforementioned (8).

Note that in one embodiment of the present invention, distribution from the logistics center to the near site is performed as an operation by the same business operator, and is not delegated to another delivery business or the like. For example, the target commodities are distributed several times a day by a distribution opportunity by the business operator itself or the like.

FIG. 2 shows an overall configuration example of the commodity delivery management system according to one embodiment of the present invention.

As shown in FIG. 2, the commodity delivery management system 20 includes a management server 21, and various information processing apparatuses that the user (customer), the deliverer and the like use (in the diagram, for example, a mobile information terminal, a smartphone, or tablet terminals 22, 27 and 28, a mobile phone 23, and PCs 24 to 26; hereinafter, collectively called “various terminals” or simply “terminals” in some cases), as a configuration according to one embodiment. The management server 21 and the various terminals are connected to each other in a communicable manner by a dedicated line or a public line such as the Internet (reference numerals 37 to 39 as wired lines) as shown in FIG. 1. The lines may be wired or wireless. In the wireless case, the mobile information terminal or the smartphones 22, 27 and 28 and the mobile phone 23 enter the Internet 39 wirelessly via a base station, an access point and the like, not shown, and are connected to the management server 21 in a mutually communicable manner via the line 38.

Here, the access point is a wireless device for connecting wireless terminals, such as PCs and smartphones, to each other, and for connecting these terminals to another network. Typically, this device operates according to communication protocols on the first layer (physical layer) and the second layer (data link layer) in the OSI reference model.

Note that many mobile phones, mobile information terminals or tablets at the time of application of the present application have a processing capability (a communication processing rate, an image processing capability, etc.) equivalent to that of a personal computer (PC), and should be called small-sized computers.

The program or software required to implement the present invention is, typically, installed or stored in an HDD, an SSD or the like in the storage of the PC or the mobile information terminal, is read, as all or some of software modules, onto the memory in the storage as required during execution of the program or the software, and is computed and executed in a CPU.

Alternatively, a browser-based computer or a mobile information terminal can be adopted. In this case, a configuration is achieved where the program is distributed from another server or computer as required, and a browser on the terminal executes this program.

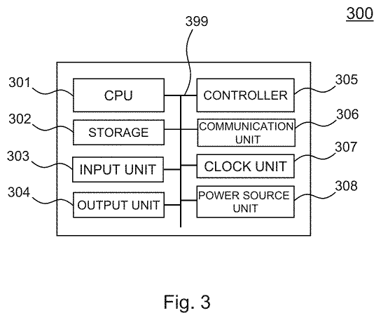

Basically, the hardware configuration of the management server 21 can basically adopt a PC (described later with reference to FIG. 3, for confirmation). Note that the present invention is not limited thereto. The management server 21 can adopt a configuration where multiple (for example, several tens of to several tens of thousands of) PCs are operated in parallel to support large-scale data processing, in order to improve the hardware specifications as required.

FIG. 3 shows a functional block diagram of the management server in the commodity delivery management system according to one embodiment of the present invention. For example, the operation of the management server is achieved by individual operations of pieces of hardware described later, and by cooperation operation between the software and these pieces of hardware.

The commodity delivery management and the like according to one embodiment of the present invention can be executed by this management server and the information processing apparatus (the delivery worker terminal and/or the user terminal) described later.

In FIG. 3, the management server 300, which is the entire hardware block, includes, in a roughly classified manner: a CPU 310 for performing various comparison and operation processes; a storage 302 including an RAM, an ROM, a flash memory and the like; an input unit 303 including a keyboard, a pointing device and the like; an output unit 304 including a display and a speaker; a controller 305 for controlling various signals; a communication (interface) unit 306 (irrespective of distinction between wireless and wired schemes); a clock unit 307 for measuring time and the like; and a power source unit 312.

These modules are appropriately connected by a communication bus and a power feeder as required (in FIG. 3, for convenience sake, these lines are collectively represented as an appropriately classified association line 399).

The program or software to be executed on the management server 300 required to implement the present invention is, typically, installed or stored in any of a hard disk drive, an SSD (Solid State Drive), a flash memory and the like that constitute the storage 302, is read, as all or some of software modules, onto the memory in the storage 302 as required during execution of the program or the software, and is computed and executed in the CPU 301.

Note that the computation and execution are not necessarily executed in a central processing unit, such as the CPU 301. Alternatively, an auxiliary operation unit, such as a digital signal processor (DSP), not shown, can be adopted.

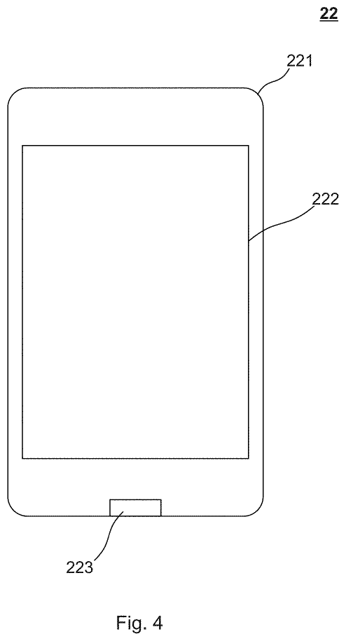

FIG. 4 illustrates an appearance configuration example of the smartphone or the tablet terminal 22 as the information processing apparatus (the delivery worker terminal and/or the user terminal) in the commodity delivery management system according to one embodiment of the present invention. In FIG. 4, the smartphone or the tablet terminal 22 includes a housing 221, a display 222, and a hardware button 223 provided at a center of a lower portion of the housing 221. The display 222 typically includes a liquid crystal display (LCD) and the like, and can display various pieces of information, such as characters, still images and moving images. A menu button and a software keyboard may be displayed on the display 222; by touching them with a finger, a touch pen (not shown) or the like, an indication (command) for the tablet terminal 22 is achieved. In view of this point, the hardware button 223 is not an indispensable configuration element. For the sake of convenience of describing the present invention, the button is implemented as a button for achieving a certain function. It is a matter of course that such hardware button 223 may be replaced with a menu button displayed at a part of the display 222.

The display 222 includes a multi-touch input panel. Touch input position coordinates on the touch input panel are transmitted to the processing system (CPU) of the smartphone or the tablet terminal 22 via an input device interface (not shown), and are processed. The multi-touch input panel is configured so as to be capable of simultaneously detecting multiple contact points on the panel. The detection (sensor) can be achieved by any of various methods, and is not necessarily limited to a contact sensor. The indication point to the panel can be extracted using an optical sensor, for example. Not only the contact sensor and the optical sensor, but also a capacitive sensor that senses contact with human skin can be adopted instead.

Although not shown in FIG. 4, the smartphone or the tablet terminal 22 may include a microphone and a speaker. In this case, the user's voice or the like picked up by the microphone can be adopted as an input command. Furthermore, although not shown in FIG. 4, a camera device, such as a CMOS, may be mounted on a back surface or the like of the smartphone or the tablet terminal 22.

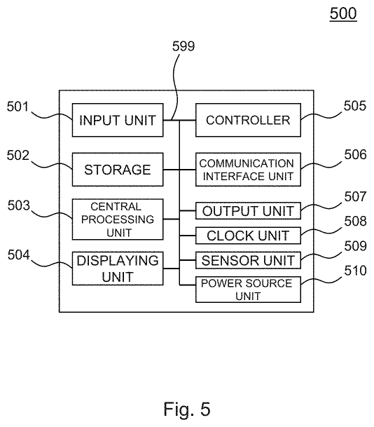

FIG. 5 exemplifies a functional block diagram of hardware constituting the smartphone or the tablet terminal 22 according to one embodiment of the present invention. The operation of the smartphone or the tablet terminal 32 is achieved by individual operations of pieces of hardware described later, and by cooperation operation between the software and these pieces of hardware.

In FIG. 5, a smartphone or a tablet terminal 500, which is the entire hardware block, includes, in a roughly classified manner: an input unit 501 that includes the hardware button 223 shown in FIG. 4, a multi-touch input panel provided on the display 222, and the microphone; a storage 502 that includes a hard disk, a RAM and/or a ROM and the like for storing the program, data and the like; a central processing unit 503 that includes an CPU performing various types of numerical calculation and logical operation through the program, a displaying unit 504 that includes the display 222 and the like; a controller 505 for controlling the chip, electric system and the like; a communication interface unit 506 that includes a slot for accessing the Internet, a port for performing optical communication, and a communication interface; an output unit 507 that includes a speaker, a vibrator, an infrared projector and the like; a clock unit 508 for measuring time or the like; a sensor unit 509 that includes an image sensor, such as a CMOS, an infrared sensor, an inertial sensor and the like; and a power source 510 as a source of supplying power to each module in the apparatus. These modules are appropriately connected by a communication bus and a power feeder as required (in FIG. 5, for convenience sake, these lines are collectively represented as an appropriately classified association line 599).

Note that the sensor unit 509 may include a GPS sensor module for identifying the position of the smartphone or the tablet terminal 500 (22). Signals detected by the image sensor, such as CMOS, the infrared sensor and the like constituting the sensor unit 509 can be processed as input information at the input unit 501.

The program or software to be executed on the smartphone or the tablet terminal 500 required to implement the present invention is, typically, installed or stored in any of a hard disk, an SSD (Solid State Drive), a flash memory and the like that constitute the storage 502, is read, as all or some of software modules, on the memory in the storage 502 as required during execution of the program or the software, and is computed and executed in the CPU 503.

Note that the computation and execution are not necessarily executed in a central processing unit 503, such as the CPU. Alternatively, an auxiliary operation unit, such as a digital signal processor (DSP), not shown, can be adopted.

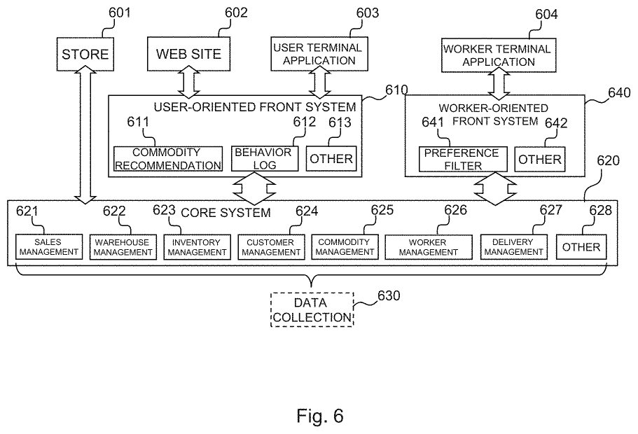

FIG. 6 shows a concept of cooperation operation in the commodity delivery management system according to one embodiment of the present invention.

The commodity delivery management system according to one embodiment of the present invention in FIG. 6 is represented in a user-oriented front system 610, a core system 620, and a worker-oriented front system 640. In this diagram, the core system 620 is configured to be accessed by (a POS register of) a store 601, by a user-oriented front system 610 for a customer-terminal-oriented web site 602 and a terminal application 603 of the customer terminal or the like, and by a delivery-worker-oriented front system 640 for the terminal application 604 of the delivery worker terminal and the like. The (POS register of) store 601 exchanges, with the core system 620, information on commodities sold at a real store or commodities and the like requested to be delivered to the real store. The web site 602 and the terminal application 603 through the user-oriented front system 610 exchanges, with the core system 620, information on commodities and the like ordered or sold through electronic commerce via the Internet or the like.

The user-oriented front system 610 is a software module serving as an intermediate about a transaction or procedures between the core 620 of the commodity delivery management system according to one embodiment of the present invention, and the customer-terminal-oriented web site 602 and the terminal application 603, such as a customer terminal, and operates on the management server 21 or another server. The front system 610 includes, as its sub-modules: a commodity recommendation logic 611 that recommend the customer terminal and the like for commodities; a behavior log logic 612 that is viewed from the customer terminal, and tracks ordered commodities; and a logic 613 made up of another processing system.

The core system 620 includes: a sales management processing system 621 including a sales management DB; a warehouse management processing system 622 including a warehouse management DB; an inventory management processing system 623 including an inventory management DB; a customer management processing system 624 including a customer management DB; a commodity management processing system 625 including a customer management DB; a delivery worker management processing system 626 including a delivery worker management DB; a delivery management processing system 627 including a delivery management DB; and another processing system 628 including another DB.

The delivery-worker-oriented front system 640 is a software module serving as an intermediate about a transaction or procedures between the core 620 of the commodity delivery management system according to one embodiment of the present invention and the terminal application 604, such as a worker terminal, and operates on the management server 21 or another server. The delivery-worker-oriented front system 640 includes, as its sub-modules: a preference filter logic 641 that issues a preference notification based on the credit rank or the like of the delivery worker; and a logic 642 made up of another processing system.

As shown in FIG. 6, collection of various data items (630) can be performed from the core system 620 that is accessed from the (POS register or the like of) store 601, the user-oriented front system 610 for the customer-terminal-oriented web site 602 and the terminal application 603, such as the customer terminal, and the delivery-worker-oriented front system 640 for the terminal application 604, such as the delivery worker terminal, and updates and manages the commodity information, sales information and the like. For example, the items can be transmitted into a data warehouse, not shown. Customer information, commodity information, purchase information (sales information), browse information and the like are collected by a data warehouse for analysis, not shown. Analysis of the accumulated data can find out various relationships.

The present invention is not limited thereto. However, the data accumulated in the data warehouse is, typically, a large amount of integrated business data orderly arranged in a time-series manner. The relationships between various items are analyzed. For example, relationships between individual elements that have not been found from a conventional simple aggregation and include “men in 40s and 50s purchasing fitness goods on weekends often purchase related books together” and “daily commodities, such as waterproof spray, sell best on days before rainy days”, are found out from sales data at the store 601.

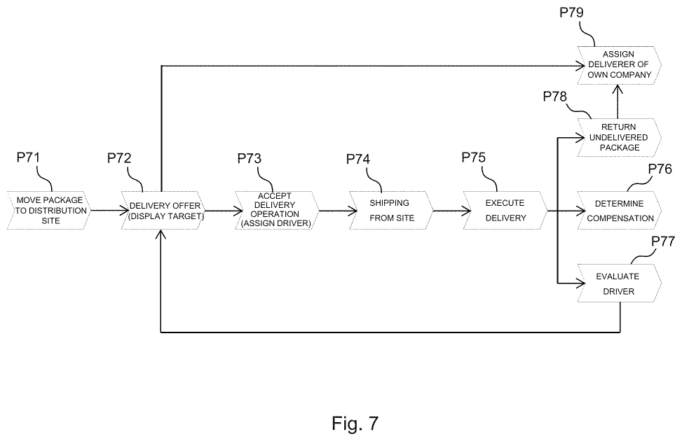

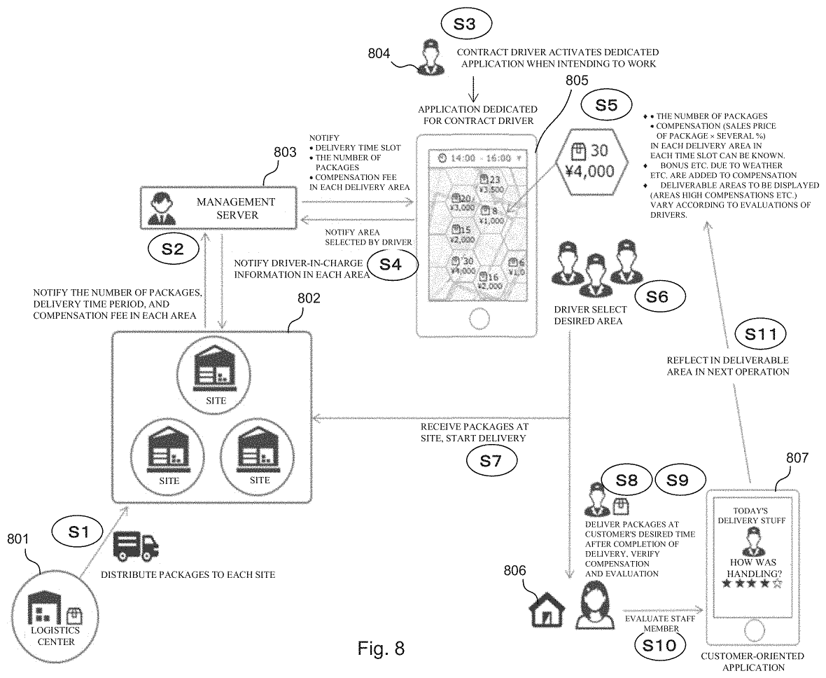

FIGS. 7 and 8 show a workflow through the commodity delivery management system according to one embodiment of the present invention. In particular, FIG. 7 shows a basic concept of the workflow. FIG. 8 shows a specific flow of the workflow.

### [Basic Concept of Present Invention]

The basic concept of the present invention is herein described again. The present invention resolves a driver shortage problem in the logistics industry, and further resolves a problem of increase in small-lot packages, a problem of requesting reduction in delivery time period, and a problem of increase in cost due to redelivery, which are present in parallel with the driver shortage problem. Furthermore, by resolving these problems, reform of working practices of workers is improved.

The commodity delivery management system according to one embodiment of the present invention provides information or services for delivery workers on behalf of insufficient drivers.

### (Situations and the Like of Delivery Workers)

The delivery workers are not necessarily full-time drivers. One embodiment of the present invention can adopt a mode where a company that operates distribution by the own company delegates driver operations to people outside of the company. Various measures are taken for drivers (delivery workers) having a delegation contract to prevent damage to the company delegating operations; the measures include that identification is strictly authenticated, a security deposit is preliminarily paid at the time of a contract through procedures, not shown (since this point is a matter of delivery operation execution itself, detailed description thereof is omitted).

The delivery worker may be an employee (staff member) of the company operating the distribution by the own company. In this case, authentication and the like of the delivery worker who is an employee (staff member) may be achieved through reuse of information or the like having already been managed in the company.

### (Method of Determining Compensations for Delivery Worker and the Like)

In one embodiment of the present invention, a method of determining a compensation for the delivery worker is not a conventional unit price scheme of determination based on a certain price per unit package, but is a variational scheme of determining several percent of the value (sales price) of a carried package. This point is one of characteristics of the present invention. Furthermore, in situations where the distribution operation is difficult owing to external factors, such as snow, a typhoon, and traffic regulations, control can be performed such that the competition principle can work by increasing the compensation allocation rate and adding an incentive bonus.

### (Information Presentation for Delivery Worker and the Like)

For the delivery worker, control is performed so as to present information on a distribution target (the area, the number of packages, the compensation fee, etc.) through the application, allow the delivery worker themselves to select a desired operation, and to assign the packages appropriately.

### (Other)

Adjustment and control can be performed such that packages that the delivery workers cannot handle (undertake delivery) are distributed by staff members of the delegating company that delegates the driver operations.

Furthermore, after completion of the delivery of packages, the customer can be asked to evaluate the delivery worker, and the evaluation can be aggregated and managed. Operations can be performed such that packages to be assigned and information to be provided can be differentiated according to the accumulated evaluation.

FIGS. 7 and 8 show a workflow through the commodity delivery management system according to one embodiment of the present invention (a part of the workflow includes what is based on a customer or user operation; hereinafter, the same applies).

As shown in FIG. 7, the workflow through the commodity delivery management system according to one embodiment of the present invention includes: a step (P71) of conveying a commodity or a package from the logistics center to the distribution site (near site) in response to an order process or the like from a customer terminal, not shown; a processing step (P72) of transmitting delivery offer information from a server, such as the management server, to the delivery worker terminal; a step (P73) of accepting a delivery operation (including driver assigning) from the delivery worker viewing the delivery offer information; a shipping step (P74) of the commodity or package to the assigned delivery worker; and a delivery step (P75) of the commodity or package by the delivery worker, the steps forming a sequential flow.

As shown in FIG. 7, there are a step (P76) of determining the compensation for the delivery worker at the time of completion of the delivery step (P75), and an evaluation step (P77) via the terminal from the customer having received the commodity or package. The contents of evaluation here are aggregated as required, and are reflected in the next delivery offer step (P72).

On the other hand, if the delivery destination is absent in the delivery step (P75), the delivery commodity (package) is once brought back to the near site by the delivery worker in the one embodiment of the present invention. Accordingly, there is a return step (P78) of returning a package undelivered owing to absence.

The commodity (package) brought back to the near site owing to absence of the delivery destination can be placed in the delivery offer step (P72) again (not shown in FIG. 7). However, here, it may be placed in a step (P79) of assigning it to a staff member of the own company delegating the driver operation, according to another example.

FIG. 8 shows a specific flow of the workflow through the commodity delivery management system according to one embodiment of the present invention, in a form where the basic concept partially overlaps the steps shown in FIG. 7. Referring to FIG. 8, description will be made on each of characteristic scenes S1 to S11 in the entire workflow.

### (S1: Conveyance of Commodity or Package to Near Site)

Here, the commodity or package is conveyed from a logistics center 801 to each area distribution site (each near site) 802. In one embodiment of the present invention, the delivery worker is not necessarily assigned to this conveyance (hereinafter, the same applies). In one embodiment, conveyance is performed by the own company or a dedicated delivery business.

### (S2: Management and the Like in Management Server)

Package information on each near site (pieces of information including the number of packages, the scheduled distribution time period, and the commodity value) is grasped and managed by a management server 803 in the delivery management system. In one embodiment of the present invention, the number of packages, the delivery time period, the compensation fee and the like with respect to each delivery destination area are notified to the management server 803 by the site server in each near site or a terminal (not shown). In one embodiment, during job offering for a delivery worker and the like, information, such as on the delivery time slot, the number of commodities (packages), and the compensation fee with respect to each delivery destination area may be notified to a delivery worker terminal 805 (including what is triggered by push notification).

In one embodiment of the present invention, upon receipt of area selection notified by the delivery worker terminal 805, information about the delivery worker in charge with respect to each delivery destination area can be notified by the management server 803 to the site server in each near site (or the terminal).

### (S3: Processing Operation of Delivery Worker (Terminal))

In one embodiment of the present invention, a delivery worker (contract driver) 804 may install a dedicated application in the own terminal 805 through means, not shown, thereby allowing the worker to activate the application and look for a job when intending to work (undertake a delivery operation). Alternatively, an intention related to the delivery operations (a desired area of the delivery destination, desired delivery time slot, etc.) may be registered through the dedicated application in advance, thereby allowing a request for a desired job to be received through a push notification.

### (S4: Setting and the Like of Desired Delivery Destination Area by Delivery Worker)

The delivery worker can set a delivery destination area and the like in which the worker intends delivery, through the terminal 805. The management server 803 is notified of the setting contents.

### (S5 to S6: Display and the Like on Dedicated Application of Delivery Worker Terminal)

On the dedicated application installed in the delivery worker terminal 805, a map including each delivery destination area, and information, such as on “delivery time slot”, “the number of packages” and “compensation fee”, is displayed. The delivery worker 804 selects the desired delivery destination area and delivery time slot, thereby performing a delivery application process. If a predetermined condition is satisfied, the delivery request process for the delivery worker 804 is determined.

As shown in FIG. 8, in one embodiment of the present invention, hexagonal cells are adopted as delivery destination areas. For each of these cells (delivery areas) displayed on the map, the number of commodities or packages to be delivered to the area and the compensation are displayed (display, such as of 30 packages and compensation 4,000 yen, is made in the cell in the diagram). The compensation fee is, for example, a several percent of the sales price of the commodity. The compensation is controlled such that a bonus can be added in consideration of the weather and the like (for example, 10% of compensation is added on rainy weather).

### (S7: Reception of Commodity (Package) at Near Site and Start of Delivery)

The delivery worker 804, for whom the delivery request process has been determined, goes to a designated near site 802 and receives the commodity (package) to be delivered. Delivery by the delivery worker 804 to the customer home 806 and the like is started here.

### (S8 to S9: Delivery of Commodity (Package) to Customer Home or the Like)

The delivery worker 804 delivers the commodity (package) to the customer home 806 or the like in conformity with the designated time. In one embodiment of the present invention, after completion of the delivery, the delivery worker 804 can verify the compensation fee and an after-mentioned evaluation on the dedicated application installed in the terminal.

### (S10 to S11: Evaluation Process of Delivery Worker and the Like)

After reception of the commodity (package), a customer 807 can evaluate the delivery worker 804 through a customer-oriented application installed in the customer terminal 807 or a website.

In one embodiment of the present invention, an evaluation result of the delivery worker 804 described above can be reflected in a preferential selection right and the like of the deliverable area and delivery target commodity (package) in the next delivery operation and thereafter. For example, as for the map display on the delivery worker terminal described above, high compensation areas and jobs are preferentially displayed on the terminal of the highly evaluated delivery worker (to this extent, this delivery worker can perform an application process for the delivery earlier than the others).

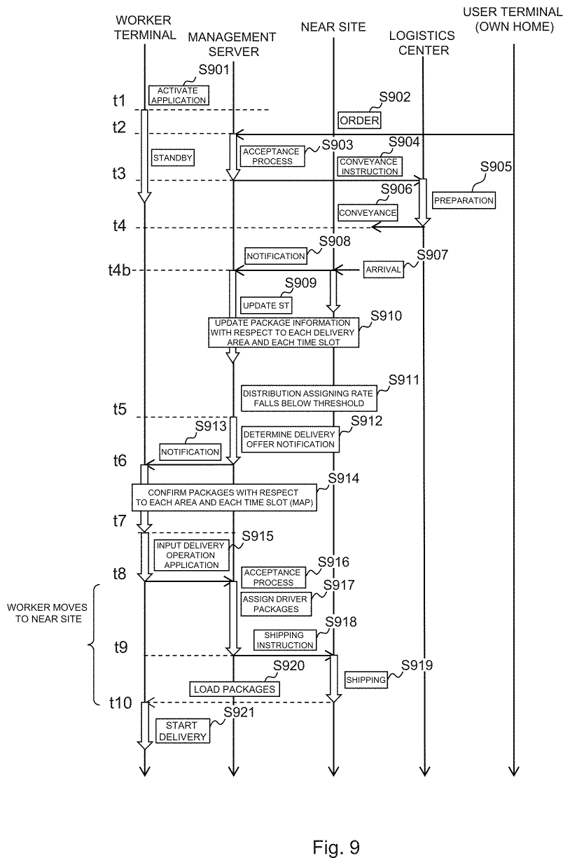

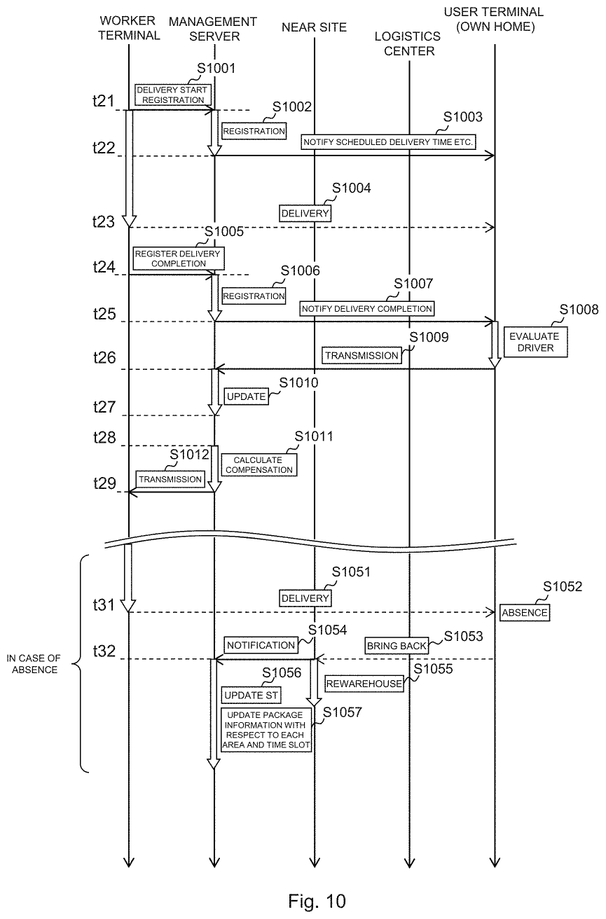

Next, FIGS. 9 and 10 show a flow of a processing operation in the commodity delivery management system according to one embodiment of the present invention. In one embodiment of the present invention, the processing operation flow shown in FIGS. 9 and 10 illustrates situations in an exemplified manner along the time flow (times t1 to t29); in the situations, the commodity (package) ordered by the customer (user) is conveyed from the logistics center to the near site, a job is offered for a driver (delivery worker) for delivery from the near site to the customer home, an appropriate commodity (package) is assigned to the delivery worker having applied through the delivery worker terminal, and the delivery worker receives the assigned commodity (package) at the near site and delivers it to the customer home. FIG. 10 illustrates an operation flow in case the customer home as the delivery destination is absent is also illustrated in an exemplified manner along the time flow (times t31 to t32).

To achieve the variation of order acceptance/distribution described with reference to FIGS. 9 and 10, the number of inventory items on a commodity-by-commodity basis at each site, the distribution time periods between sites, and the distribution time period to the customer home are managed on the core system, are recalculated at every opportunity, and are updated and controlled. After shipped, the commodity is tracked, the current position of the commodity on delivery is updated and managed, the scheduled arrival time is recalculated in response to an additional order or change in ordered details, and the customer terminal and the mobile terminal of the deliverer can be appropriately notified of the recalculated time.

At time t1 in FIG. 9, the delivery worker activates the dedicated application through the own terminal (delivery worker terminal) (step S901). It is assumed that required processes including installation and the like are completed at this time point.

Although the present invention is not limited thereto, the delivery worker subsequently waits for information notification about a delivery offer or the like (coming into what is called a standby state).

At time t2 (which is not necessarily after t1; this is only an example), the order process for the commodity is performed from the user terminal to the management server (step S902), and from time t2 to t3, the order acceptance process is performed in the management server (step S903). In the order acceptance process in step S903, it is found out that the ordered commodity is stocked in the logistics center, at time t3, a conveyance instruction for the ordered commodity from the logistics center to the near site is issued from the management server to the logistics center server (or terminal) (step S904).

From time t3 to t4, in the logistics center, shipping preparation of the ordered commodity is prepared (step S905). At time t4, conveyance is started (step S906). At time t4b, the ordered commodity arrives at the near site (step S907), and a notification about the arrival is issued from the near site server (or terminal) to the management server (step S908).

The management server having received the notification in step S908 updates the status information about ordered commodity management (step S909). Package management information with respect to each delivery destination area and each delivery time slot is updated and processed (step S910).

### [Package Management Information]

In one embodiment of the present invention, what is shown in the following table is adopted as an ordered commodity management table managed in the management server.

TABLE 1

| Commodity ID of | Current position | Delivery destination |
|---|---|---|
| ordered commodity | (inventory site) | information |
| [symbol] | [symbol] | [symbol] |

[symbol]

indicates data missing or illegible when filed

Identification information (besides a JAN code, a management code or the like numbered originally by the own company) that can uniquely identify the commodity is adopted as the commodity ID of the ordered commodity. In the current position (inventory site), position information on where the ordered commodity is (where it is stored, or being moved) is recorded and managed. In the delivery destination information, besides the address (including the area) designated by the orderer, the destination name, the desired delivery date and time information and the like are recorded and managed as required, or link information to these pieces of information is recorded.

In one embodiment of the present invention, what is shown in the following table is adopted as a package management information table, with respect to each delivery destination area and each delivery time slot, managed by the management server.

TABLE 2

| Commodity ID | Delivery | Delivery | Delivery | Desired |
|---|---|---|---|---|
| of ordered | destination | destination | destination | delivery date |
| commodity | area | address | name | and time |
| [symbol] | [symbol] | [symbol] | [symbol] | [symbol] |

[symbol]

indicates data missing or illegible when filed

Note that in one embodiment, the management server may appropriately calculate and manage a scheduled delivery compensation fee based on the price of the ordered commodity with respect to each delivery destination area. In this case, the fee can be orderly arranged with respect to each delivery destination area and each desired delivery time slot.

Alternatively, in one embodiment, the management server may appropriately calculate and manage a scheduled delivery compensation fee based on the scheduled traveling distance with respect to each delivery destination area.

Although not shown in FIG. 9, processing is performed also for other many ordered commodities simultaneously in parallel. The management server appropriately or always manages the distribution assigning rate (in one embodiment of the present invention, a setting threshold for determining what percent of the entire line of commodities required to be distributed is to be delegated to the delivery worker and the operation is thus performed). If the rate falls below a threshold, processing is performed such that the operation is delegated to the delivery worker (for example, an offer notification about the delivery worker and the like).

In FIG. 9, it is assumed that the distribution assigning rate actually falls below the threshold by time t5 (step S911).

At time t5, the management server detects that the distribution assigning rate falls below the threshold, and for example, a process of determining how to issue the delivery offer notification is performed (step S912). Specifically, when there are delivery workers to be preferentially notified, these workers are extracted and preferentially notified.

At time t6, a notification about offering jobs for delivery is issued to the delivery workers to be notified (step S913).

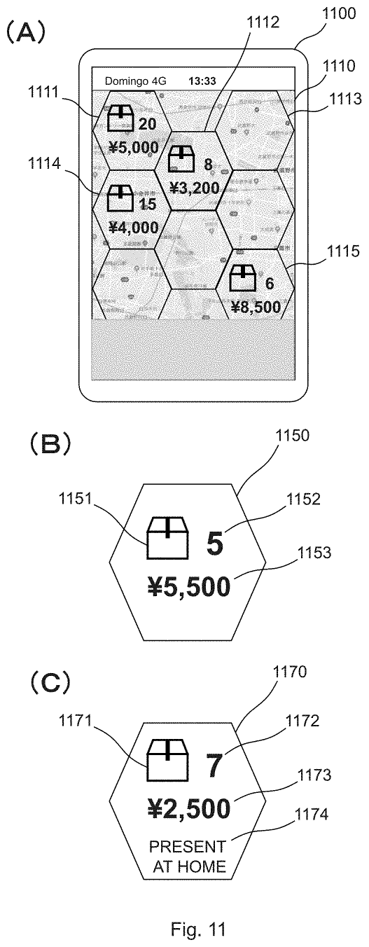

From time t6 to time t7, the notified delivery worker (step S913) accesses the management server or the like via the own terminal (delivery worker terminal), and packages with respect to each area and each time slot are confirmed (step S914). This is confirmation of presenting information, such as the number of packages and the compensation fee, displayed on the map. In one embodiment of the present invention, this is a screen shown in FIG. 11.

As shown in FIG. 11(A), a map including the delivery destination is displayed on a screen 1110 of a delivery worker terminal 1100. The display is made so as to be divided with respect to each delivery destination area. In one embodiment of the present invention, individual division is performed into hexagonal cells 1111 to 1115 and the like. In the cells 1111, 1112, 1114 and 1115, the number of packages to be delivered to the area, and compensations to be obtained after delivery thereof (including the estimated fee or the scheduled fee) are displayed. For example, the cell 1111 indicates that the number of packages to be delivered to this area is 20, and the compensation obtained when they are delivered is 5,000 yen.

In one embodiment of the present invention, the delivery worker selects (clicks or taps) an area that they intend to perform (undertake) delivery, from the presented information, to cause the screen to transition to a screen, not shown, thus performing a delivery application process for all or some of the packages in the area (described later).

In relation to FIG. 11(A), FIGS. 11(B) and 11(C) show variations of display of the packages in the cell according to one embodiment of the present invention. FIG. 11(B) shows a display method similar to that of FIG. 11(A), and shows an icon 1151 indicating presence of packages to be delivered, the number 1152 of packages, and the compensation 1153 obtained after delivery thereof (including a scheduled fee and an expected fee), in the cell 1150. In addition to icon 1171 corresponding to 1151, the number 1172 corresponding to 1152 and the compensation 1173 corresponding to 1153, presence-at-home information 1174 on the delivery destination in the delivery destination area is also displayed in the cell 1170 in FIG. 11(C). When the number of delivery destinations in the delivery destination area is one, the fact whether the state is “present at home” or “absent” is displayed by obtaining the position information and/or the status information on the user terminal, not shown. When there are multiple delivery destinations in the same area, the current presence-at-home ratio may be displayed.

Not only current presence-at-home ratio but also the ratio in the past can be displayed at the presence-at-home information 1174. By such information presentation, it can be preliminarily known whether the delivery operations in the same area smoothly advances or not.

Returning to FIG. 9 again, from time t7 to time t8, the delivery worker performs the application process (applying process) for the delivery operation through the delivery worker terminal (step S915). The interface example has been described above with reference to FIG. 11.

At time t8, an acceptance process is performed by the management server (step S916). From time t8 to time t9, a process of assigning the packages to the delivery worker (driver) is performed (step S917). At time t9, an instruction for shipping the assigned packages is issued from the management server to the near site (step S918). From time t9 to t10, at the near site, shipping preparation for the packages instructed by the management server is performed (step S919).

Note that in one embodiment of the present invention, after input of the application for the delivery operations at time t8, in response to a notification about a reception place (near site) for the packages pertaining to the delivery operation issued by the management server, the delivery worker moves to the near site.

At time t10, the delivery worker reaches the near site instructed by the management server, and the packages prepared for shipping preparation are loaded (step S920).

After time t10, the delivery worker having completed the package loading starts delivery to the delivery destination (step S921).

FIG. 10 shows an operation flow subsequent to FIG. 9. In one embodiment, after the delivery worker starts delivery at time t21, a delivery start registration process is performed according to procedures, not shown, through the delivery worker terminal (step S1001). The management server performs the registration process (times t21 to t22, step S1002) refers to a database managed by itself and the like, calculates the scheduled delivery time to the delivery destination, and notifies the delivery destination (for example, the user terminal at user's home) of the scheduled delivery time (time t22, step S1003).

At time t23, the delivery worker reaches, with the packages, the user's home at the delivery destination, and delivers the packages to the user at home (step S1004). In one embodiment, the packages are delivered to the user by hand. Alternatively, other delivery means, such as a delivery locker, may be used.

Next, the delivery worker having completed the delivery performs a delivery completion registration application process, in the management server through the terminal (time t24, step S1005). From time t24 to time t25, the management server performs the delivery completion registration process (step S1006). From the management server to the user terminal, a delivery completion notification about the packages having been delivered is transmitted (time t25, step S1007).

From time t25 to time t26, the user inputs an evaluation of the delivery worker (driver) having visited to deliver the packages through the user terminal, (step S1008). At time t26, the input evaluation is transmitted to the management server (step S1009), and evaluation information, such as the rank of the evaluated delivery worker is updated (time t26 to time t27, step S1010).

The present invention is not limited to this timing. In one embodiment, from time t28 to time t29, the compensation for the delivery worker is calculated (step S1101), and a calculation result is transmitted to the delivery worker terminal (time t29, step S1012). Accordingly, the delivery worker can confirm the compensation fee obtained by the delivery this time.

Note that another embodiment of the present invention may have a configuration where at timing after time t24 when the delivery worker performs the delivery completion registration application process, the scheduled compensation fee can be calculated and can be referred to by viewing through the delivery worker terminal. In this case, if the evaluation by the user is not bad, the scheduled compensation fee is not reduced. When a specifically high evaluation is obtained from the user, a little bonus or tip or a point is sometimes added to the scheduled compensation fee.

From time t21 to time 29 in FIG. 10, the operation flow in the case where the user at the delivery destination is present has thus been described. Hereinafter, an example of an operation flow in a case where the user at the delivery destination is absent is described (time t31 to t32 and thereafter).

At time t31 in FIG. 10, it is assumed that the delivery worker reaches, with the packages, the user's home at the delivery destination (step S1051), but unfortunately the user is absent (step S1052). In one embodiment of the present invention, the packages are brought back by the delivery worker unless there is an exceptional situation (a delivery locker is installed at the delivery destination) (time t32, step S1053).

At this time, absence registration is performed through the delivery worker terminal (not shown), and from the delivery worker terminal to the management server via the near site server (or terminal), or from the delivery worker terminal directly to the management server, a notification thereabout (absence) is issued (time t32, step S1054).

Meanwhile, the packages brought back to the near site by the delivery worker are rewarehoused (step S1055).

In one embodiment of the present invention, at timing on and after time t32, the status information on the packages brought back to the near site owing to absence is updated, and the package management information with respect to each delivery destination area and each delivery time slot is updated and processed (step S1057). In one embodiment, the packages subsequently become standby for redelivery.

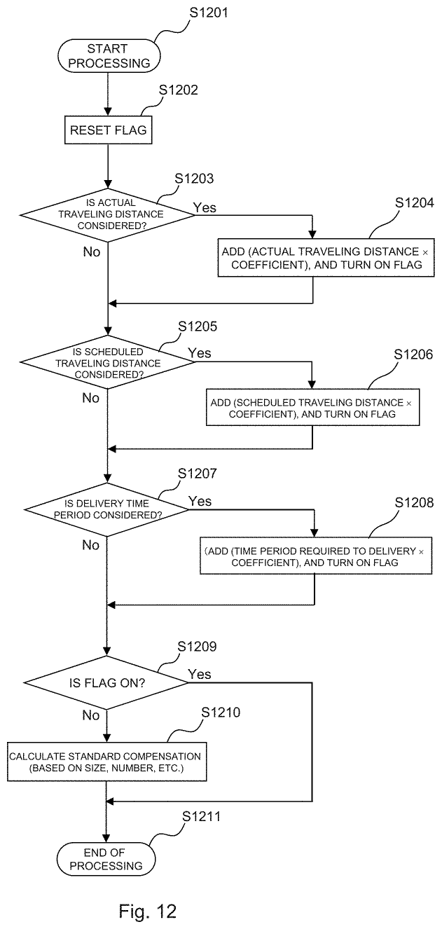

FIG. 12 shows a processing operation flow in the commodity delivery management system according to one embodiment of the present invention. In one embodiment of the present invention, the processing operation flow shown in FIG. 12 is executed in step S1011 in FIG. 10. There is, however, no limitation thereto. Also at the time of updating package information with respect to each delivery area and each delivery time slot in step S910 in FIG. 9, scheduled package delivery information with respect to each delivery area, not shown, can be compiled and preliminarily calculated as a scheduled compensation fee on an area-by-area basis.

After the processing is started in step S1201, the processing proceeds to step S1202, in which a flag (for managing a status, described later) is reset. Typically, the flag is initialized to zero.

In step S1203, for determination (calculation) of the compensation, it is determined whether an actual traveling distance required for delivery is considered or not. In one embodiment, presence or absence of such a determination process itself is switched according to setting in the management server or the like. In the case of No in step S1203, the processing proceeds to step S1205. In the case of Yes, the processing proceeds to step S1204, in which addition is performed to the compensation on the basis of the actual traveling distance (in one embodiment, multiplication by a coefficient, not shown, is made). The flag is then turned on.

In step S1205, for determination (calculation) of the compensation, it is determined whether the scheduled traveling distance required for delivery is considered or not. In one embodiment, presence or absence of such a determination process itself is switched according to setting in the management server or the like. In the case of No in step S1205, the processing proceeds to step S1207. In the case of Yes, the processing proceeds to step S1206, in which addition is performed to the compensation on the basis of the scheduled traveling distance (in one embodiment, multiplication by a coefficient, not shown, is made). The flag is then turned on.

In step S1207, for determination (calculation) of the compensation, it is determined whether the time period required for delivery is considered or not. In one embodiment, presence or absence of such a determination process itself is switched according to setting in the management server or the like. In the case of No in step S1207, the processing proceeds to step S1209. In the case of Yes, the processing proceeds to step S1208, in which addition is performed to the compensation on the basis of the time period required for delivery (in one embodiment, multiplication by a coefficient, not shown, is made). The flag is then turned on.

In step S1209, it is determined whether the flag has been turned on at least in any of steps S1203, S1205 and S1207. In the case of Yes, the processing is skipped to step S1211, in which this flow is finished. In the case of No, the processing proceeds to step S1210, in which a standard compensation (for example, based on the sizes and the number of packages and the like) is calculated.

Note that addition based on steps S1204, S1206 and S1208 is not prevented from being redundantly considered. However, the addition may be alternative. In the latter case, in steps S1205 and S1207, “the flag is still off” is added as an AND condition to the determination.

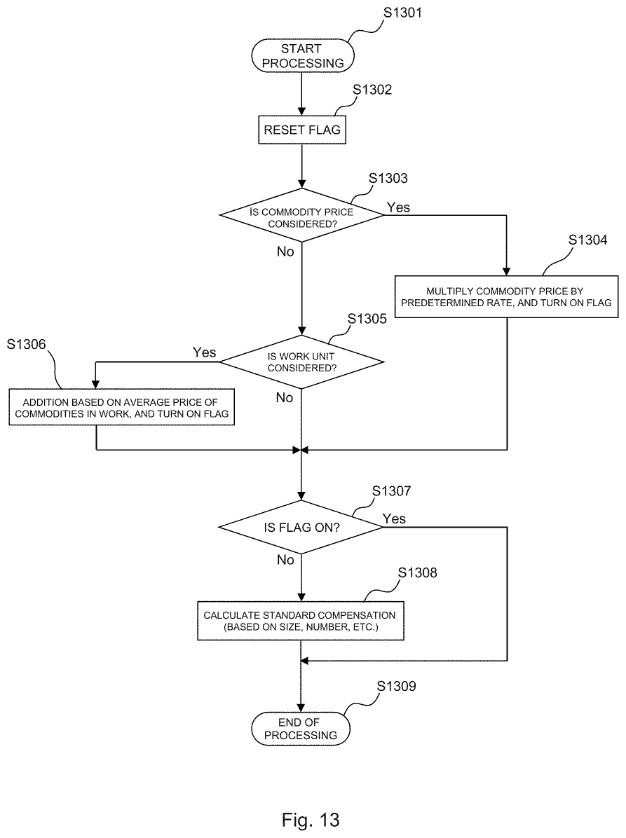

FIG. 13 shows a processing operation flow in the commodity delivery management system according to another embodiment of the present invention. The processing operation flow shown in FIG. 13 is an alternative flow of the processing operation flow shown in FIG. 12, but can be used along with a part or the whole of the processing operation flow shown in FIG. 12 unless a logical contradiction occurs. Hereinafter, description is made with reference to FIG. 12.

After the processing is started in step S1301, the processing proceeds to step S1302, in which a flag (for managing a status, described later) is reset. Typically, the flag is initialized to zero.

In step S1303, for determination (calculation) of the compensation, it is determined whether the commodity price is considered or not. In one embodiment, presence or absence of such a determination process itself is switched according to setting in the management server or the like. In the case of No in step S1303, the processing proceeds to step S1305. In the case of Yes, the processing proceeds to step S1304, in which addition is performed to the compensation on the basis of the commodity price (in one embodiment, multiplication by a rate, not shown, is made). The flag is then turned on.

In step S1305, for determination (calculation) of the compensation, it is determined whether a work unit is considered or not. Here, the work unit is an aggregation (group) of any number of packages. Typically, the work unit is configured on an area-by-area basis. Among packages in a certain delivery destination area, 10 packages may be grouped as one work, or other five packages may be grouped as one work. Such a group is recorded and managed as a group by the management server or the like.

In one embodiment, presence or absence of such a determination process itself is switched according to setting in the management server or the like. In the case of No in step S1305, the processing proceeds to step S1307. In the case of Yes, the processing proceeds to step S1306, in which the compensation is calculated on the basis of the average price of the commodities in the work (in one embodiment, multiplication by a rate, not shown, is made). The flag is then turned on.

In step S1307, it is determined whether the flag has been turned on at least in any of steps S1304 and S1306. In the case of Yes, the processing is skipped to step S1309, in which this flow is finished. In the case of No, the processing proceeds to step S1308, in which a standard compensation (for example, based on the sizes and the number of packages and the like) is calculated.

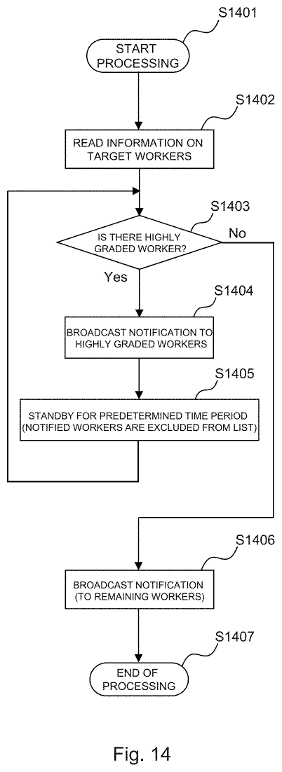

FIG. 14 shows a processing operation flow in the commodity delivery management system according to one embodiment of the present invention. In one embodiment of the present invention, the processing operation flow shown in FIG. 14 is executed in steps S912 and S913 in FIG. 9. Specifically, as to notification to the delivery workers, time differences are provided according to their evaluations (among the workers wishing the same area and delivery time slot, highly evaluated workers are preferentially notified).

Hereinafter, detailed description is made.

After start of the processing in step S1401, the processing proceeds to step S1402, in which information about the delivery workers to be notified is read. For example, the delivery workers having preferences with respect to each delivery destination area and each delivery time slot are read from the database, and are listed, for example.

Next, the processing proceeds to step S1403. It is determined whether there is any highly graded worker in the read list or not. For example, if there are a group of workers having a rank A and a group of workers having a rank B, those in the group of workers having the rank A are assumed as highly graded workers. Alternatively, if there are groups of workers having ranks A to E, those having the most highly graded rank A are assumed as highly graded workers.

In the case of No in step S1403, the processing proceeds to step S1406 (workers having different grades or ranks are not present in this case), a notification is broadcast to the delivery workers remaining in the list, and this flow is finished (step S1407). In the case of Yes in step S1403, the processing proceeds to step S1404, in which the highly graded workers in the list (the highest workers if there are three or more grades) are extracted, a notification is preferentially broadcast to them. The processing then proceeds to step S1405, in which the processing stands by for a predetermined time period (for example, any time period, such as 5 minutes or 10 minutes). In this period, the workers to which the notification has been broadcast in the previous step are excluded from the list serving as the notification target.

Next, the processing returns to step S1403, in which it is determined whether there are highly graded (or most highly graded) workers in the remaining list or not. Hereinafter, every time of determination of Yes, the processes in steps S1404 and S1405 described above are repeated.

The processing is then returned to step S1403. In the case of determination of No in this step, a notification is broadcast to the delivery workers having last grades (rank) (step S1406), and this flow is finished (step S1407).

The embodiment of the commodity delivery management system and the like has been described based on the specific examples. However, besides a method or a program for implementing a system or an apparatus, a storage medium storing a program (for example, an optical disk, a magneto-optical disk, a CD-ROM, a CD-R, a CD-RW, magnetic tape, a hard disk, and a memory card) and the like can be adopted as embodiments of the present invention.

Program implementation modes are not limited to application programs, such as object code to be compiled by a compiler, and program code to be executed by an interpreter, and may be modes, such as program modules and the like implemented in an operating system.

Furthermore, not all the processes of the program are necessarily executed only on a CPU on a control board. A configuration may be adopted where some or all of the processes are executed by another processing unit (DSP etc.) implemented on an extension board or an extension unit, as required.

All the configuration elements described in this specification (including claims, abstract and drawings) and/or all the disclosed methods or all the steps of processes can be combined according to any combination except combinations with the features being exclusive from each other.

Each of the features described in this specification (including claims, abstract and drawings) can be replaced with an alternative feature functioning for an identical purpose, an equivalent purpose, or a similar purpose, unless explicitly negated. Consequently, unless explicitly negated, the disclosed features are only examples of a comprehensive series of the identical or equivalent features.

Furthermore, the present invention is not limited to any of the specific configurations of the embodiments described above. The present invention can be extended to all the novel features described in this specification (including claims, abstract and drawings) or a combination thereof, or all the described novel methods or steps of processes, or a combination thereof.

### REFERENCE SIGNS LIST

10 Commodity delivery management system (part of logistics system)
11-13 Logistics center
14-16 Near site
141-142, 151-153, 162-165, 199 Customer home
20 Commodity delivery management system executing commodity search method
21 Management server
22 Smartphone or tablet terminal (one mode of delivery worker terminal and user terminal)
23 Mobile phone (one mode of delivery worker terminal and user terminal)
24-26 PC (one mode of delivery worker terminal and user terminal)
27-28 Smartphone or tablet terminal (one mode of delivery worker terminal and user terminal)
37, 38 Communication line
39 Public line (dedicated line, Internet, etc.)

1. A computer program executed on a commodity delivery management system comprising: a management server that manages delivery of a commodity from one or more near sites each having, as a delivery coverage area, a predetermined area allowing distribution to a customer home in a predetermined time period, to the customer home; a terminal of the customer; and a terminal of a delivery worker undertaking delivery of the commodity ordered from the terminal of the customer, the program being executed for assigning the delivery worker the commodity to be delivered,
wherein when being executed on the system, the program causes the management server to execute:
a step of issuing, to the terminal of the delivery worker, a delivery offer notification that presents the commodity for each delivery destination area, and a compensation fee receivable when the commodity is delivered, for the sake of the assigning; and
a step of allowing the delivery worker to which the delivery offer notification has been issued, to select the commodity for each delivery area, through the terminal of the delivery worker.

2. The program according to claim 1, wherein the compensation fee receivable when the commodity is delivered is determined according to a sales price of the commodity.

3. The program according to claim 1, wherein when the commodity is delivered to the customer home, an evaluation of the delivery worker having delivered the commodity is made through the terminal of the customer, and the evaluation is reflected in a rank of the delivery worker.

4. The program according to claim 3, wherein the offer notification is a notification that is issued preferentially according to the rank of the delivery worker.

5. A commodity delivery management system comprising: a management server that manages delivery of a commodity from one or more near sites each having, as a delivery coverage area, a predetermined area allowing distribution to a customer home in a predetermined time period, to the customer home; a terminal of the customer; and a terminal of a delivery worker undertaking delivery of the commodity ordered from the terminal of the customer,
wherein for assigning the delivery worker the commodity to be delivered, the management server issues, to the terminal of the delivery worker, a delivery offer notification that presents the commodity for each delivery destination area, and a compensation fee receivable when the commodity is delivered, and
allows the delivery worker to which the delivery offer notification has been issued, to select the commodity for each delivery area, through the terminal of the delivery worker.

6. The system according to claim 5, wherein the compensation fee receivable when the commodity is delivered is determined according to a sales price of the commodity.

7. The system according to claim 5, wherein when the commodity is delivered to the customer home, an evaluation of the delivery worker having delivered the commodity is made through the terminal of the customer, and the evaluation is reflected in a rank of the delivery worker.

8. The system according to claim 7, wherein the offer notification is a notification that is issued preferentially according to the rank of the delivery worker.

9. The program according to claim 2, wherein when the commodity is delivered to the customer home, an evaluation of the delivery worker having delivered the commodity is made through the terminal of the customer, and the evaluation is reflected in a rank of the delivery worker.

10. The program according to claim 9, wherein the offer notification is a notification that is issued preferentially according to the rank of the delivery worker.

11. The system according to claim 6, wherein when the commodity is delivered to the customer home, an evaluation of the delivery worker having delivered the commodity is made through the terminal of the customer, and the evaluation is reflected in a rank of the delivery worker.

12. The system according to claim 11, wherein the offer notification is a notification that is issued preferentially according to the rank of the delivery worker.
